(19) United States
(12) Patent Application Publication
(10) Pub. No.: US 2026/0302642 A1
(43) Pub. Date: Oct. 1, 2026

(54) BASE STATION ANTENNAS HAVING METAMATERIAL LENSES AND RELATED METAMATERIAL LENSES

(71) Applicant: Outdoor Wireless Networks LLC, Richardson, TX (US)

(72) Inventors: Jimmy Ho, Hickory, NC (US); Nicolas Uribe, Denver, NC (US); Lance Darren Bamford, Pittsford, NY (US); Desigan Prabaharan, Chennai (IN); Raghuvaran D, Chennai (IN); Kamalaveni A, Chennai (IN); Ganesh Balasubramanian, Chennai (IN)

(21) Appl. No.: 19/578,056

(22) Filed: Mar. 25, 2026

Related U.S. Application Data
(60) Provisional application No. 63/888,623, filed on Sep. 26, 2025.

(30) Foreign Application Priority Data
Mar. 26, 2025 (IN) 202541028464

(51) Int. Cl. H01Q 19/06; H01Q 1/24

(52) U.S. Cl. CPC H01Q 19/06; H01Q 1/246

(57) ABSTRACT

An antenna comprises one or more radio frequency radiators operating in combination with at least one lens comprising a plurality of substantially planar substrates having conductive scattering elements formed thereon, the substrates being oriented in three dimensional space such that they create a sphere containing sparsely-distributed conductive scattering elements throughout its volume. The invention provides an improved beam shape for applications in mobile radio base stations and is suitable for use with antennas having circular, linear or dual orthogonal-linear polarization.

### CROSS-REFERENCE TO RELATED APPLICATION

The present application claims priority to U.S. Provisional Patent Application Ser. No. 63/888,623, filed Sep. 26, 2025 and to Indian Provisional Patent Application No. 202541028464, filed Mar. 26, 2025, the entire content of each of which is incorporated herein by reference as if set forth fully herein.

### FIELD

The present invention relates to radio communications and, more particularly, to lensed base station antennas suitable for use in cellular communications networks.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors” in the azimuth plane (the azimuth plane is a horizontal plane that bisects the base station antenna that is parallel to the plane defined by the horizon), and separate base station antennas provide coverage to each of the sectors. The base station antennas are often mounted on a tower or other raised structure, with the radiation patterns (“antenna beams”) that are generated by the antennas directed outwardly to provide service to the respective sectors. Reference will also be made herein to the elevation plane, which refers to a plane that is perpendicular to the azimuth plane that bisects the front surface of the base station antenna.

A common base station configuration is a “three sector” configuration in which a cell is divided into three 120° sectors in the azimuth plane. A three sector base station typically includes three base station antennas that provide coverage to the three respective sectors. Typically, each base station antenna will include one or more phase-controlled arrays of dual-polarized radiating elements, with the radiating elements arranged in one or more columns when the base station antenna is mounted for use. Each column may include one or more radiating dual-polarized elements. A dual-polarized radiating element is a radiating element that includes a first radiator that transmits and receives RF energy at a first polarization and a second radiator that transmits and receives RF energy at a second polarization that is orthogonal to the first polarization. Each column of radiating elements is coupled to a pair of ports of a radio through respective first and second polarization feed networks. RF signals input at the first radio port are split into a plurality of sub-components by the first polarization feed network and fed to the first polarization radiators of the radiating elements in the column. The first polarization radiators radiate the sub-components of the RF signal into free space, generating a first antenna beam. Similarly, RF signals received from the second radio port are split into a plurality of sub-components by the second polarization feed network and fed to the second polarization radiators of the radiating elements in the column, thereby generating a second antenna beam.

The phases of the sub-components of the RF signals that are fed to the different radiating elements in a column may be set (e.g., by the length of the RF transmission lines in the feed networks) so that the RF energy radiated by the different radiating elements constructively combine to narrow the beamwidth of the antenna beam in the column direction. Narrower antenna beams concentrate the RF energy into a smaller area, thereby increasing the gain of the antenna beam. The above-described columns of radiating elements are typically referred to as “linear arrays” of radiating elements. Note that some of the radiating elements in the column may be staggered in the horizontal direction to narrow the azimuth beamwidth of the antenna beams generated by the linear array.

The shape of each antenna beam generated by a linear array of radiating elements is defined by, among other things, the characteristics of the individual radiating elements, the characteristics of the array (e.g., whether the array is a single radiating element or a column of radiating elements, the vertical spacing between adjacent radiating elements in the linear array, and any horizontal stagger in the column) and by the magnitudes and phases of the sub-components of the RF signal that are fed to each individual radiating element in the linear array. Antenna beams are often characterized by their Half Power Beam Width (“HPBW”). The HPBW refers to the number of degrees, in a designated plane such as the azimuth or elevation planes, where the radiated power of a main lobe of the antenna beam is within 3 dB (50%) of the peak power of the antenna beam. Typically, the radiating elements used in base station antennas that are designed to cover a 120° sector in the azimuth plane are configured to generate an “element” radiation pattern (i.e., the antenna beam formed by a single radiating element) that has a HPBW in both the azimuth and elevation planes of about 65°, which ensures that the antenna beam generated by each radiating element provides good coverage throughout the 120° sector. The sub-components of the RF signal that are fed to the different radiating elements in the column may be phased so that the radiation patterns generated by each subset of one or more radiating elements constructively combine to produce a composite antenna beam having a narrowed HPBW (e.g., 5°-25°) in the elevation (vertical) plane.

As capacity requirements have grown, cellular network operators are now dividing some cells into more than three sectors. For example, cells may now be divided into six, nine, twelve, fifteen or eighteen sectors in the azimuth plane. Typically, multibeam “sector-splitting” antennas are used when cells are divided into more than three sectors. A multibeam sector-splitting antenna refers to a base station antenna that generates multiple antenna beams (per polarization) that have narrowed beamwidths in the azimuth plane (i.e., azimuth HPBWs of less than 65°, and typically less than about 35°), where the pointing directions of the multiple antenna beams are designed to split a sector into a plurality of sub-sectors. This allows a single base station antenna to generate the multiple antenna beams (per polarization) that provide coverage to the respective sub-sectors of a 120° sector.

For example, a six-sector base station will divide each 120° sector in the azimuth plane into two 60° sub-sectors. Such a six-sector base station will typically be served by three base station antennas that are each implemented as a “twin-beam” antenna that is designed to generate first and second antenna beams (per polarization) that provide coverage to the respective first and second 60° sub-sectors of each 120° sector. Each antenna beam may have a HPBW in the azimuth plane of about 30-350. The first antenna beam may point at an angle of about −27° to −30° in the azimuth plane from the “boresight” pointing direction of the antenna and the second antenna beam may point at an angle of about 27° to 30° in the azimuth plane from the “boresight” pointing direction of the antenna. The boresight pointing direction of the antenna is the center, in the azimuth plane, of the 120° sector served by the antenna. In this fashion, the 120° sector is split into two 60° sub-sectors that are covered by the respective first and second antenna beams (per polarization).

There are two common approaches used to implement a multibeam antenna. In the first approach, a multi-column array of radiating elements is provided that is coupled to a beamforming network such as a Butler Matrix based beamforming network. Multiple RF signals (per polarization) are input to the beamforming network, which sub-divides the signals and feeds the signals to the multi-column array. The beamforming network may be configured to generate a separate antenna beam for each RF signal that is input thereto, and also electronically steers the generated antenna beams so that they point in different directions. Such an antenna may be designed to generate an antenna beam (per polarization) for each sub-sector of a sector served by the antenna, with the antenna beams pointed toward the respective sub-sectors.

The second approach used to implement a multibeam antenna is to include a plurality of linear arrays in an antenna that are arranged behind one or more RF lenses. The RF lenses are used to narrow the beamwidths (in the azimuth and possibly the elevation planes) of the antenna beams generated by the base station antenna, thereby increasing the gain of the antenna beams. Each linear array is positioned so that its generated antenna beams will pass through the RF lenses and be directed toward the respective sub-sectors. The RF lens acts to narrow the generated antenna beams in at least the azimuth plane so that each antenna beam will have an appropriate size to provide service to a respective sub-sector of the sector served by the base station antenna. RF lenses conventionally have been formed using dielectric materials such as polyethylene, and often used a combination of dielectric materials having different relative permittivities to achieve a desired focusing effect. Unfortunately, the size, weight and/or cost of such dielectric lenses is often prohibitive if substantial narrowing of the antenna beams is required. The use of metamaterial RF lenses has also been suggested. Metamaterials, which are also called artificial dielectric materials, refer to a class of materials that have properties that are not usually found in naturally occurring materials, such as a negative refractive index. Metamaterial RF lenses typically comprise a plurality of conductive elements that are small in terms of the wavelengths of the RF energy that is to be focused (e.g., the largest dimension of each conductive element is less than half the smallest a wavelength of the RF energy that is to be focused, and often less than one-tenth of the smallest wavelength). For example, U.S. Patent Publication No. 2024/0347922 (“the '922 publication”) discloses various metamaterial RF lenses that are suitable for use in base station antennas.

Providing cellular service in large venues such as stadiums, arenas, convention centers, concert halls and the like may be particularly challenging, as very larger numbers of users may be located in a very small area. In such venues, multibeam sector-splitting base station antennas that generate three or more antenna beams per polarization may be used, where each antenna beam provides coverage to a respective 20°-40° (or smaller) sub-sector in the azimuth plane. When a 120° sector is sub-divided into sub-sectors, the system capacity can be increased significantly because the RF energy of each antenna beam is focused into a smaller area and therefore provides a higher antenna gain.

Spherical RF lenses have been used in base station antenna applications. A spherical RF lens acts to narrow the beamwidths of antenna beams incident thereon in both the azimuth and elevation planes. A well-known example of a spherical RF lens is the Lüneburg lens. An ideal spherical Lüneburg lens has a dielectric constant (Dk) that conforms to the following formula:

$$Dk = 2 * [ 1 - {( r / R )}^{2} ] \qquad ( 1 )$$

where R is the radius of the Lüneburg lens and r is a particular location along the radius R. A spherical Lüneburg lens thus has a dielectric constant that is highest in the center of the lens and that decreases with increasing distance from the center of the lens according to Equation (1) above. In practice, it is difficult or impossible to form a lens that has a continuously changing dielectric constant, and hence practical Lüneburg lenses are formed as a series of concentric spherical shells where each successively larger shell has a lower relative permittivity, and the thickness and dielectric constants of the shells are selected to form a step approximation of a Lüneburg lens. In some cases, the shells may be hollow shells that are filled with dielectric particles (including artificial dielectric material particles), as is disclosed, for example, in U.S. Pat. No. 10,256,551. A plurality of radiating elements may be arranged orbitally around one side of such a spherical Lüneburg lens to provide a lensed station antenna.

### SUMMARY

Pursuant to embodiments of the present invention, base station antennas are provided that comprise a radiating element and an RF lens. The RF lens comprises a set of first laminae, each first laminae extending radially outward from an axis, and a set of second laminae, each second laminae intersecting at least two of the first laminae. The radiating element is configured to radiate toward the RF lens.

In some embodiments, each second laminae extends in a respective plane that is parallel to planes defined by the major surfaces of each first laminae.

In some embodiments, a first number of first laminae in the set of first laminae exceeds a second number of second laminae in the set of second laminae. In some embodiments, a thickness of at least one of the second laminae exceeds a thickness of at least one of the first laminae. In other embodiments, a thickness of at least one of the second laminae exceeds thicknesses of every one of the first laminae.

In some embodiments, each first laminae may comprise a planar dielectric substrate and a plurality of conductive scattering elements on at least one major surface of the planar dielectric substrate, and each second laminae comprises a dielectric substrate which optionally may have one or more conductive scattering elements on at least one major surface thereof. In such embodiments, a density of conductive scattering elements on at least one of the first laminae may exceed a density of conductive scattering elements on at least one of the second laminae. In some embodiments, respective densities of conductive scattering elements on each of the first laminae may exceed a density of conductive scattering elements on at least one of the second laminae. In still other embodiments, respective densities of conductive scattering elements on each of the first laminae exceed respective densities of conductive scattering elements on each of the second laminae.

In some embodiments, each first laminae may comprise a planar dielectric substrate and a plurality of conductive scattering elements on at least one major surface of the planar dielectric substrate, and at least one of the second laminae may be devoid of conductive scattering elements. In some cases all of the second laminae may be devoid of conductive scattering elements.

In some embodiments, each first laminae includes a straight edge and a curved edge that connects to opposed ends of the straight edge. The curved edges of the first laminae may define an ellipsoid such as a sphere. In some embodiments, the first laminae and the second laminae may be semicircular laminae. In some embodiments, the RF lens further comprises a cylindrical support element, and the straight edges of the first laminae are received within slots in the cylindrical support element.

In some embodiments, a boresight pointing direction of the radiating element may be parallel to a plane defined by a major surface of a first of the second laminae. In some embodiments, the radiating element is a first radiating element, the base station antenna further comprising a second radiating element that is configured to radiate toward the RF lens, where a boresight pointing direction of the second radiating element is parallel to the plane defined by the major surface of the first of the second laminae.

Pursuant to further embodiments of the present invention, base station antennas are provided that comprise a radiating element and an RF lens. The RF lens comprises a set of first laminae, each first laminae extending in a respective one of a plurality of vertical planes, and a set of second laminae, each second laminae extending in a respective one of a plurality of horizontal planes. The radiating element is configured to radiate toward the RF lens. Each first laminae comprises a planar dielectric substrate and a plurality of conductive scattering elements on at least one major surface of the planar dielectric substrate.

In some embodiments, a first number of first laminae in the set of first laminae exceeds a second number of second laminae in the set of second laminae.

In some embodiments, a thickness of at least one of the second laminae exceeds a thickness of at least one of the first laminae. In some embodiments, the thickness of the at least one of the second laminae exceeds thicknesses of every one of the first laminae.

In some embodiments, a density of conductive scattering elements on at least one of the first laminae exceeds a density of conductive scattering elements on at least one of the second laminae. In some embodiments, at least one of the second laminae is devoid of conductive scattering elements.

In some embodiments, each first laminae includes a straight edge and a curved edge that connects to opposed ends of the straight edge. In some embodiments, the curved edges of the first laminae define a sphere. In some embodiments, the RF lens further comprising a cylindrical support element, and the straight edges of the first laminae are received within slots in the cylindrical support element.

In some embodiments, a boresight pointing direction of the radiating element is parallel to a plane defined by a major surface of a first of the second laminae.

Pursuant to additional embodiments of the present invention, base station antennas are provided that comprise a radiating element and an ellipsoid RF lens. The ellipsoid RF lens comprises a set of first laminae, each first laminae extending radially outward from a central axis, and a set of second laminae, each second laminae perpendicular to the central axis. The radiating element is configured to radiate toward the RF lens. A first number of first laminae in the set of first laminae exceeds a second number of second laminae in the set of second laminae.

In some embodiments, the first number is at least twice the second number. In other embodiments, the first number is at least four time the second number.

In some embodiments, a thickness of at least one of the second laminae exceeds a thickness of at least one of the first laminae. In some embodiments, the thickness of the at least one of the second laminae exceeds thicknesses of every one of the first laminae.

In some embodiments, each of the first laminae comprises a planar dielectric substrate and a plurality of conductive scattering elements on at least one major surface of the planar dielectric substrate. In some embodiments, a density of conductive scattering elements on at least one of the first laminae exceeds a density of conductive scattering elements on at least one of the second laminae. In some embodiments, at least one of the second laminae is devoid of conductive scattering elements.

In some embodiments, each first laminae includes a straight edge and a curved edge that connects to opposed ends of the straight edge, the ellipsoid RF lens further comprising a cylindrical support element, where the straight edges of the first laminae are received within slots in the cylindrical support element.

Pursuant to still further embodiments of the present invention, base station antennas are provided that comprise a radiating element and an RF lens. The RF lens comprises a set of first laminae, each first laminae extending in a respective one of a plurality of vertical planes, and a set of second laminae, each second laminae extending in a respective one of a plurality of horizontal planes. The radiating element is configured to radiate toward the RF lens. Each first laminae comprises a planar dielectric substrate and a plurality of conductive scattering elements on at least one major surface of the planar dielectric substrate and each second laminae comprises a dielectric substrate, and a density of conductive scattering elements on at least one of the first laminae exceeds a density of conductive scattering elements on at least one of the second laminae.

In some embodiments, a first number of first laminae in the set of first laminae exceeds a second number of second laminae in the set of second laminae. In some embodiments, a thickness of at least one of the second laminae exceeds a thickness of at least one of the first laminae. In some embodiments, a thickness of at least one of the second laminae exceeds thicknesses of every one of the first laminae.

In some embodiments, the density of conductive scattering elements on the at least one of the first laminae exceeds a density of conductive scattering elements on all of the second laminae. In some embodiments, at least one of the second laminae is devoid of conductive scattering elements.

In some embodiments, each first laminae includes a straight edge and a curved edge that connects to opposed ends of the straight edge. In some embodiments, the curved edges of the first laminae define a sphere. In some embodiments, the RF lens further comprising a cylindrical support element, wherein the straight edges of the first laminae are received within slots in the cylindrical support element.

Pursuant to yet additional embodiments of the present invention, base station antennas are provided that comprise a radiating element and an RF lens. The RF lens comprises a set of first laminae, each first laminae extending in a respective one of a plurality of vertical planes, and a set of second laminae, each second laminae extending in a respective one of a plurality of horizontal planes. The radiating element is configured to radiate toward the RF lens. A thickness of at least one of the second laminae exceeds a thickness of at least one of the first laminae.

In some embodiments, each first laminae comprises a planar dielectric substrate and a plurality of conductive scattering elements on at least one major surface of the planar dielectric substrate. In some embodiments, a first number of first laminae in the set of first laminae exceeds a second number of second laminae in the set of second laminae. In some embodiments, a thickness of at least one of the second laminae exceeds thicknesses of every one of the first laminae. In some embodiments, at least one of the second laminae is devoid of conductive scattering elements.

In some embodiments, each first laminae includes a straight edge and a curved edge that connects to opposed ends of the straight edge. In some embodiments, the curved edges of the first laminae define a sphere. In some embodiments, the RF lens further comprising a cylindrical support element, wherein the straight edges of the first laminae are received within slots in the cylindrical support element.

Pursuant to other embodiments of the present invention, antennas are provided that comprise a spherical RF lens that comprises a set of first laminae that extend radially outward from an axis and a radiating element arranged to radiate towards the spherical RF lens. Angles between adjacent first laminae are substantially equal, and each of the first laminae comprises a planar dielectric substrate having an arrangement of conductive scattering elements thereon, where the number of conductive scattering elements per unit area increases with increasing distance from the axis.

In some embodiments, each planar dielectric substrate comprises a semicircular laminae, and curved edges of the planar dielectric substrates together define a sphere. In some embodiments, the spherical RF lens further comprises a cylindrical support element, wherein the straight edges of the planar dielectric substrates are received within slots in the cylindrical support element. In some embodiments, the planar dielectric substrate of each of the first laminae includes a plurality of elongate linear openings that extend radially inwards from the curved edge. In some embodiments, the spherical RF lens further comprises a set of second laminae, each second laminae intersecting at least one of the first laminae. In some embodiments, the axis is a first axis, and wherein each of second laminae extends radially outward from a second axis. In some embodiments, the first axis is perpendicular to the second axis. In some embodiments, each of the second laminae comprises a planar substrate having an arrangement of conductive scattering elements thereon, where the number of conductive scattering elements per unit area increases with increasing distance from the second axis.

Pursuant to still other embodiments of the present invention, antennas are provided that comprise a spherical RF lens that comprises a set of first laminae that extend radially outward from a first axis, each of the first laminae comprising a planar dielectric substrate having conductive scattering elements thereon, where the number of conductive scattering elements per unit area increases with increasing distance from the axis, and a set of second laminae, each second laminae extending radially outward from a second axis, each of the second laminae comprising a dielectric substrate having conductive scattering elements thereon and a radiating element arranged to radiate towards the spherical RF lens.

In some embodiments, angles between adjacent first laminae are substantially equal. In some embodiments, the first axis is perpendicular to the second axis. In some embodiments, each second laminae intersects at least one of the first laminae. In some embodiments, angles between adjacent second laminae that intersect the same first laminae are substantially equal.

In some embodiments, each planar dielectric substrate comprises a semicircular laminae, and curved edges of the planar dielectric substrates together define a sphere. In some embodiments, the spherical RF lens further comprises a cylindrical support element, wherein the straight edges of the planar dielectric substrates are received within slots in the cylindrical support element. In some embodiments, the planar substrate of each of the second laminae comprises conductive scattering elements thereon, where the number of conductive scattering elements per unit area increases with increasing distance from the second axis. In some embodiments, the planar dielectric substrate of each of the first laminae includes a plurality of first slots that extend radially inwards from the curved edge. In some embodiments, each second laminae includes at least one second slot that extends radially outward.

### BRIEF DESCRIPTION OF THE DRAWINGS

FIG. 1 is a schematic perspective view of a spherical RF lens according to embodiments of the present invention that comprises a plurality of semicircular laminae that include conductive scattering elements.

FIG. 2A is a schematic front view of two of the semicircular laminae that are included in the spherical RF lens of FIG. 1 and a graph illustrating the amount of phase change imparted to an RF signal that passes through the two laminae in different sections of the two laminae.

FIG. 2B is a schematic front view of two alternative semicircular laminae that could be included in the spherical RF lens of FIG. 1 and a graph illustrating the amount of phase change imparted to an RF signal that passes through the two alternative laminae in different sections thereof.

FIG. 3 is a schematic perspective view of internal components of a base station antenna according to embodiments of the present invention that includes a practical implementation of the spherical RF lens of FIG. 1.

FIG. 4 is a schematic perspective view of internal components of another base station antenna according to embodiments of the present invention.

FIG. 5 is a graph of the simulated co-polar and cross-polar elevation radiation patterns generated by the base station antenna of FIG. 3.

FIG. 6 is a schematic perspective view of internal components of yet another base station antenna according to embodiments of the present invention.

FIG. 7 is a graph of the simulated co-polar and cross-polar radiation patterns generated by the base station antenna of FIG. 6.

FIG. 8 is a series of perspective views of sectors of laminae included in the base station antenna of FIG. 6 that illustrates how the spherical RF lens included in the antenna can be constructed.

FIG. 9 is a schematic exploded perspective view of the spherical RF lens included in the base station antenna of FIG. 6 with a callout that illustrates support elements that hold the laminae in place.

FIGS. 10A and 10B are a schematic perspective view and a schematic top view, respectively, of internal components of a base station antenna according to still further embodiments of the present invention.

FIG. 11 is schematic perspective view of the base station antenna of FIGS. 10A-10B with a weatherproof dielectric cover installed.

FIG. 12 is schematic perspective view of internal components of a base station antenna according to still further embodiments of the present invention that includes a spherical RF lens that is illuminated by a co-phased pair of radiating elements spaced laterally by a half wavelength.

FIGS. 13A and 13B are a schematic perspective view and a schematic top view, respectively, of internal components of a base station antenna according to additional embodiments of the present invention.

FIG. 14A is a graph of the simulated co-polar and cross-polar elevation radiation patterns generated by the base station antenna of FIGS. 13A-13B.

FIG. 14B is a graph of the simulated co-polar and cross-polar azimuth radiation patterns generated by the base station antenna of FIGS. 13A-13B.

FIG. 14C is a graph of the measured co-polar and cross-polar elevation radiation patterns generated by the base station antenna of FIGS. 13A-13B at frequencies in the range of 3.3-4.0 GHz.

FIG. 14D is a graph of the measured co-polar and cross-polar azimuth radiation patterns generated by the base station antenna of FIGS. 13A-13B at frequencies in the range of 3.3-4.0 GHz.

FIGS. 15A and 15B are a schematic perspective view and a schematic top view, respectively, of internal components of a base station antenna according to yet additional embodiments of the present invention.

FIG. 16A is a graph of the measured co-polar elevation radiation patterns generated by the base station antenna of FIGS. 15A-15B at frequencies in the range of 3.3-4.0 GHz.

FIG. 16B is a graph of the measured co-polar azimuth radiation patterns generated by the base station antenna of FIGS. 15A-15B at frequencies in the range of 3.3-4.0 GHz.

FIG. 17 is a schematic perspective view of internal components of another base station antenna according to another embodiment of the present invention.

Two-part reference numerals that comprise two numbers that are separated by a hyphen are used herein to refer to multiple like elements. The full two-part reference numeral may be used to refer to individual instances of the element while the first part of the two-part reference numeral may be used to refer to all of the instances of the element collectively

### DETAILED DESCRIPTION

One difficulty with RF lenses for base station antennas that use conventional dielectric lens material is that if substantial narrowing of the antenna beam is required, the diameter of the RF lens may need to be a substantial number of wavelengths of the RF signals that are to be transmitted and received through the RF lens, and hence each RF lens may be large in size. While the use of higher dielectric constant material may reduce the size of the RF lens, higher dielectric constant lens materials tend to be heavy and expensive, and hence are generally not used.

Pursuant to embodiments of the present invention, base station antennas are provided that are formed using one or more metamaterial-based ellipsoid (e.g., spherical) RF lenses. The metamaterial-based RF lenses may have properties that are similar to the properties of a Lüneburg lens, and may be constructed using an assembly of substantially planar laminae such as conventional printed circuit boards and plastic substrates, resulting in a lightweight, low cost assembly that has simple manufacturing requirements.

In some embodiments, the metamaterial-based RF lenses may comprise a set of first laminae that extend radially outward from a common axis so that the laminae define a sphere. Each first laminae may include a vertically-extending major surface. Each first laminae may comprise, for example, a semicircular dielectric substrate that has a plurality of conductive scattering elements thereon that are used to focus RF energy that is incident on the RF lens. In other embodiments, metamaterial-based RF lenses are provided that comprise a set of first laminae that extend radially outward from a first axis as well as a set of second laminae that extend radially outward from a second axis that is perpendicular to the first axis. Each first laminae and each second laminae may comprise, for example, a semicircular dielectric substrate that has a plurality of conductive scattering elements thereon that are used to focus RF energy that is incident on the RF lens, and the first and second laminae may be arranged to define a sphere. In still other embodiments, metamaterial-based RF lenses are provided that comprise a set of first laminae that extend radially outward from a vertical axis as well as a set of second laminae that extend in respective horizontal planes. Each first laminae may comprise a semicircular dielectric substrate that has a plurality of conductive scattering elements thereon, while each second laminae may comprise a dielectric substrate that has fewer or no conductive scattering elements thereon.

Example embodiments of the present invention will now be discussed in greater detail with reference to the accompanying drawings.

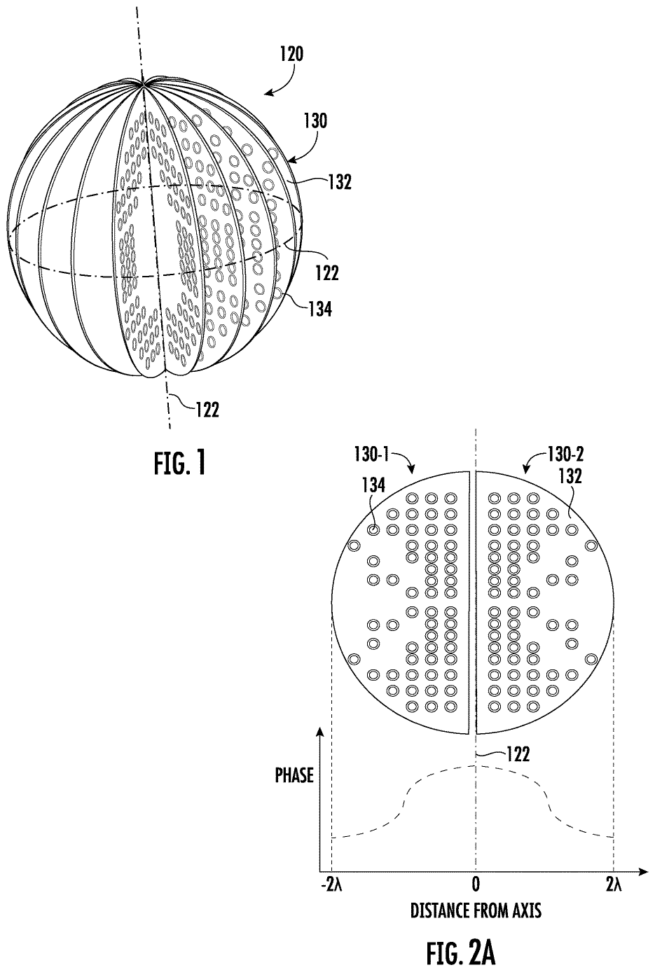

FIG. 1 is a schematic perspective view of a spherical RF lens 120 according to certain embodiments of the present invention. As shown in FIG. 1, spherical RF lens 120 comprises a plurality of first laminae 130. Each first lamina 130 comprises a dielectric substrate 132 and a plurality of conductive scattering elements 134 that are formed on the dielectric substrate 132. In the embodiment of FIG. 1, each first laminae 130 comprises a planar semicircular structure. Each first laminae 130 may be implemented, for example, using a semicircular printed circuit board, with the dielectric substrate of each printed circuit board forming the dielectric substrate 132 and the metallization layer(s) of each printed circuit board forming the conductive scattering elements 134. It will be appreciated, however, that the first laminae 130 may be implemented using other techniques, such as, for example, using plastic substrates (which act as the dielectric substrate 132) with one or more metallization patterns formed thereon that form the conductive scattering elements 134. The conductive scattering elements 134 may comprise, for example, any of the conductive scattering elements disclosed in U.S. Provisional Patent Application Ser. No. 63/812,936 (“the '936 application”), filed May 28, 2025. The entire content of the '936 application is incorporated herein by reference as if set forth in its entirety. It will also be appreciated that the conductive scattering elements that are included in the other RF lens described herein may similarly be implemented using, for example, any of the conductive scattering elements disclosed in the '936 application.

As shown in FIG. 1, the first laminae 130 extend radially outwardly from a polar axis 122 of the spherical RF lens 120. The straight edges of the first laminae 130 are all arranged to extend from the same segment of the polar axis 122 so that the first laminae 130 together define a sphere. Each first laminae 130 may be spaced apart from adjacent first laminae 130 by a constant angle so that the first laminae 130 are uniformly distributed within the volume of the sphere. For example, if twenty first laminae 130 are included in spherical RF lens 120, then adjacent first laminae 130 will be radially spaced apart from each other by 18°. The first laminae 130 will focus RF energy received from an RF source such as a radiating element, that lies, for example, in an equatorial plane 124 of the spherical RF lens 120. The focusing characteristics of the spherical RF lens 120 will vary with the angle of incidence of energy radiated into the spherical RF lens 120 from the RF source. When the first laminae 130 are implemented using thin dielectric substrates (e.g., 0.76 mm thick FR4 substrates of conventional printed circuit boards), the spherical RF lens 120 may be both lightweight and low cost, and is also simple to manufacture.

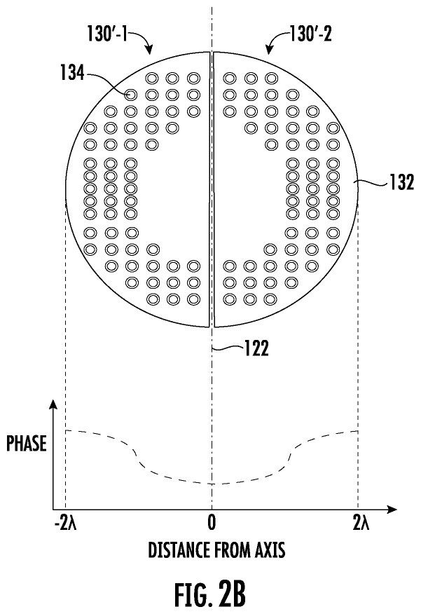

FIG. 2A is a schematic front view of two of the first laminae 130 that are included in the spherical RF lens 120 of FIG. 1 and a graph illustrating the amount of phase change imparted to an RF signal that passes through the two first laminae 130 in different sections thereof. A plurality of conductive scattering elements 134 are formed on the dielectric substrate 132 of each first laminae 130-1, 130-2. As shown, in this example, the density of conductive scattering elements 134 is high in locations close to the polar axis 122, and the density of conductive scattering elements 134 decreases with increasing distance from the polar axis 122. As a result, the spacing between adjacent conductive scattering elements 134 generally increases with increasing distance from the polar axis 122.

The graph in FIG. 2A shows the amount of phase shift that is imparted to an RF signal that is propagating in a direction normal to the plane defined by a major surface of the first laminae 130-1, 130-2. In the regions of the first laminae 130-1, 130-2 that are proximate the polar axis 122, where the density of conductive scattering elements 134 is high, the RF signal is subjected to a relatively large phase shift, while in regions distant from the polar axis where the density of conductive scattering elements 134 is low, the RF signal is subject to a relatively smaller phase delay. In the example of FIG. 2A, the diameter of the circle defined by the two first laminae 130 is two wavelengths at 2 GHz.

FIG. 2B is a schematic plan view of two first laminae 130′-1, 130′-2 that have an alternative arrangement of conductive scattering elements 134 to that shown in FIG. 2A. The first laminae 130′ may be used in place of the first laminae 130 shown in FIG. 2A to form a spherical RF lens that is an alternative embodiment of spherical RF lens 120. As shown in FIG. 2B, in this alternative spherical RF lens, the density of conductive scattering elements 134 on each first laminae 130′ increases with increasing distance from the polar axis 122. As shown in the graph in FIG. 2B, in this case, RF signals propagating through the first laminae 130′ in the region near the polar axis 122 experience a smaller phase shift than do RF signals that propagate through regions that are distant from the polar axis 122.

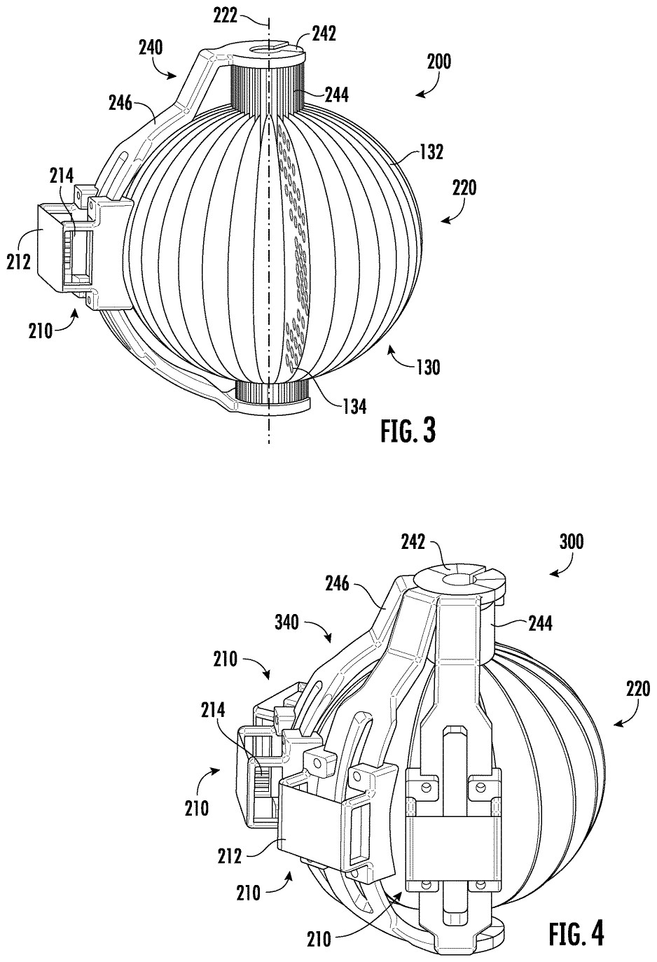

FIG. 3 is a schematic perspective view of internal components of a base station antenna 200 according to embodiments of the present invention that includes a spherical RF lens 220 that is a practical implementation of the spherical RF lens 120 of FIG. 1. As shown in FIG. 3, base station antenna 200 includes a radiating element assembly 210, the spherical RF lens 220 and a support frame 240. The radiating element assembly 210 comprises a reflector 212 and a radiating element 214. The reflector 212 may comprise, for example, a grounded metal plate or a grounded bowl-shaped metal piece. The radiating element 214 is mounted to extend forwardly from the reflector 212 (i.e., in the direction of the spherical RF lens 220). The radiating element 214 may comprise, for example, a cross-dipole radiating element that includes first and second dipole radiators that are configured to transmit and receive RF radiation at orthogonal polarizations. In the depicted embodiment, radiating element 214 is a slant +/−45° linearly polarized cross-dipole radiating element that has a slant −45° polarization dipole radiator and a and a slant +45° polarization dipole radiator. It will be appreciated, however, that other radiating elements may be used such as patch or horn radiating elements, and that the radiating element 214 may be a single-polarized or a dual-polarized radiating element.

The spherical RF lens 220 comprises a plurality of substantially semicircular first laminae 230. Each first laminae 230 comprises a planar dielectric substrate 232 that includes a plurality of conductive scattering elements 234 on at least one major surface thereof. The first laminae 230 may be identical to the first laminae 130 of RF lens 120 or may have different arrangements of conductive scattering elements 234. The first laminae 230 extend radially outwardly from a polar axis 222 that extends vertically through the center of spherical RF lens 220. The angles between each adjacent pair of first laminae 230 may be equal, as shown (e.g., twenty first laminae 230 may be provided where adjacent first laminae 230 are spaced apart by 18°).

The support frame 240 comprises a cylindrical dielectric member 242 that has a plurality of longitudinal slots 244 formed therein and an arcuate member 246 that connects to the upper and lower ends of the cylindrical dielectric member 242. The radiating element assembly 210 is movably mounted on the arcuate member 246 so that the radiating assembly 210 can be moved either upwardly or downwardly from the position shown in FIG. 3 along the arcuate member 246. The arcuate member 246, in turn, is rotationally mounted on the cylindrical dielectric member 242. Thus, the radiating element assembly 210 can be moved in both the azimuth and elevation planes so that RF radiation emitted by radiating element 214 may be directed toward a desired portion of the outer surface of the spherical RF lens 220.

In practice, base station antenna 200 will typically be mounted so that the longitudinal axis of the cylindrical dielectric member 242 (and hence the polar axis 222) extends vertically or nearly vertically. When mounted in this fashion, rotation of the arcuate member 246 about cylindrical dielectric member 242 acts to adjust the pointing direction of the antenna beams generated by base station antenna 200 in the azimuth plane. The pointing direction of the generated antenna beams in the elevation plane is adjusted by sliding radiating element assembly 210 along arcuate member 246. Locking arrangements (not shown) may be provided to ensure that the antenna beam pointing direction remains fixed after adjustment of the position of the radiating element assembly 210.

FIG. 4 is a schematic perspective view of internal components of another base station antenna 300 according to further embodiments of the present invention. Base station antenna 300 is identical to base station antenna 200 of FIG. 3, except that base station antenna 300 includes four radiating element assemblies 210 and the support frame 340 of base station antenna 300 includes four arcuate members 246, whereas base station antenna 200 only includes a single radiating element assembly 210 and a support frame 240 that has a single arcuate member 246. Since each radiating element 214 generates a pair of antenna beams (one at each polarization), base station antenna 300 can generate four times the number of antenna beams that base station antenna 200 can generate. The four pairs of antenna beams that are generated by base station antenna 300 provide coverage to different sub-sectors of a coverage area. While base station antenna 300 is shown as having four arcuate members 246 and four radiating element assemblies 210, it will be appreciated that this is simply one example, and that different numbers of arcuate members 246 and radiating element assemblies 210 may be provided. The maximum number of radiating element assemblies 210 that may be supported by a single spherical RF lens may be determined by the permissible extent of mutual interaction between the radiating elements 214, such interactions including coupling between radiating elements 214 that can result in degradation of the co-polar and cross-polar antenna patterns of the generated antenna beams.

FIG. 5 is a graph of the simulated co-polar and cross-polar elevation radiation patterns at a frequency of 2 GHz for the base station antenna of FIG. 3 in which the spherical RF lens 220 comprises twenty semicircular first laminae 230 that each have a diameter of 200 mm. The azimuth HPBW beamwidth of the generated antenna beams is approximately 35°, and the directivity of the generated antenna beams is approximately 13 dB. Peak sidelobes are below −16 dB relative to maximum level of the main lobe. While the co-polar radiation pattern is satisfactory, the cross-polar discrimination obtained is higher than is required for some applications. This is explained by the fact that when viewed from the position of radiating element 215, many of the scattering elements are seen from an oblique angle such that their major axes are vertical.

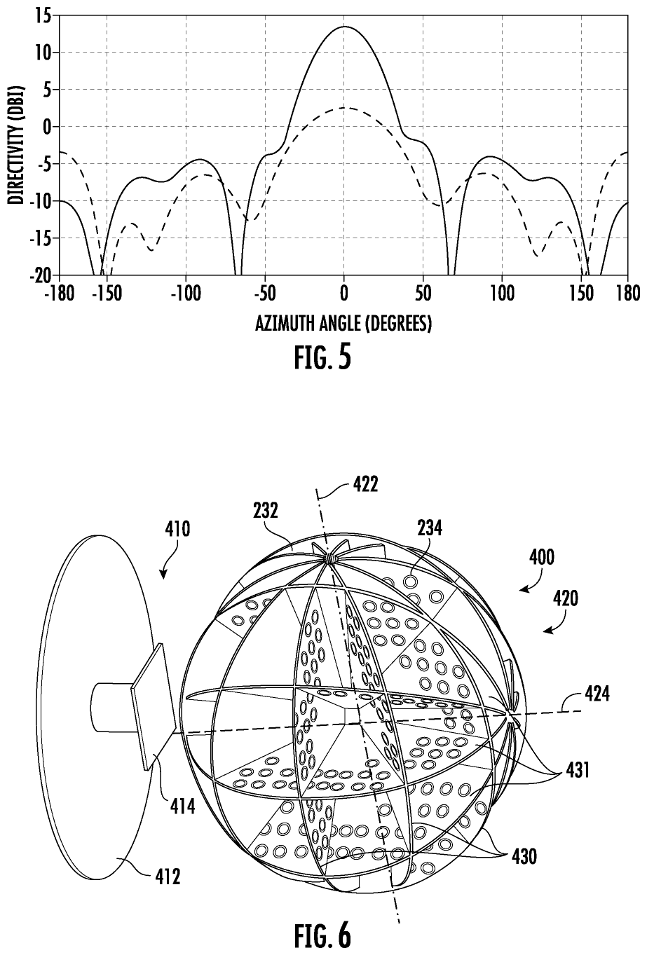

FIG. 6 is a schematic side perspective view of internal components of a base station antenna 400 according to further embodiments of the present invention. As shown in FIG. 6, base station antenna 400 includes a radiating element assembly 410 and a spherical RF lens 420. Base station antenna 400 may also include a support frame (not shown). The support frame may, for example, be similar to the support frame 240 of base station antenna 200 of FIG. 3.

The spherical RF lens 420 comprises a set of first laminae 430 that extend radially outwardly from a first axis 422, and a set of second laminae 431 that extend radially outwardly from a second axis 424. Each first laminae 430 and each second laminae 431 may be almost identical to the first laminae 130 included in the spherical RF lens 220 of base station antenna 200 of FIG. 3, and thus may comprise a planar dielectric substrate 232 with a plurality of conductive scattering elements 234 formed on at least one side thereof. The dielectric substrates 232 have a semicircular shape and hence have a straight edge and a curved edge that connects to opposed ends of the straight edge. The first and second laminae 430, 431 may differ from the first laminae 230 of spherical RF lens 220 in that the dielectric substrates 232 of the first and second laminae 430, 431 may include cooperating slots that allow the second laminae 431 to intersect and mate with the first laminae 430. For example, the dielectric substrates 232 of each first laminae 430 may include a plurality of slots that extend outwardly to the curved edge thereof while each second laminae 431 may include a plurality of slots that extend in to the straight edge thereof. Note that to better show the arrangements of conductive scattering elements 234, the number of first laminae 430 and second laminae 431 is reduced in RF spherical lens 420 as compared to spherical RF lens 220 of FIG. 3. It will be appreciated that practical antennas would typically include a larger number of first and second laminae 430, 431 to increase the degree of focusing provided by RF spherical lens 420.

RF spherical lens 420 has first and second laminae 430, 431 that include conductive scattering elements 134 that extend radially outward from two different, perpendicular axes 422, 424. As a result, RF spherical lens 420 is less dependent on the plane of polarization of the incident RF signal than are the RF spherical lens 220 included in the base station antennas 200, 300 of FIGS. 3 and 4.

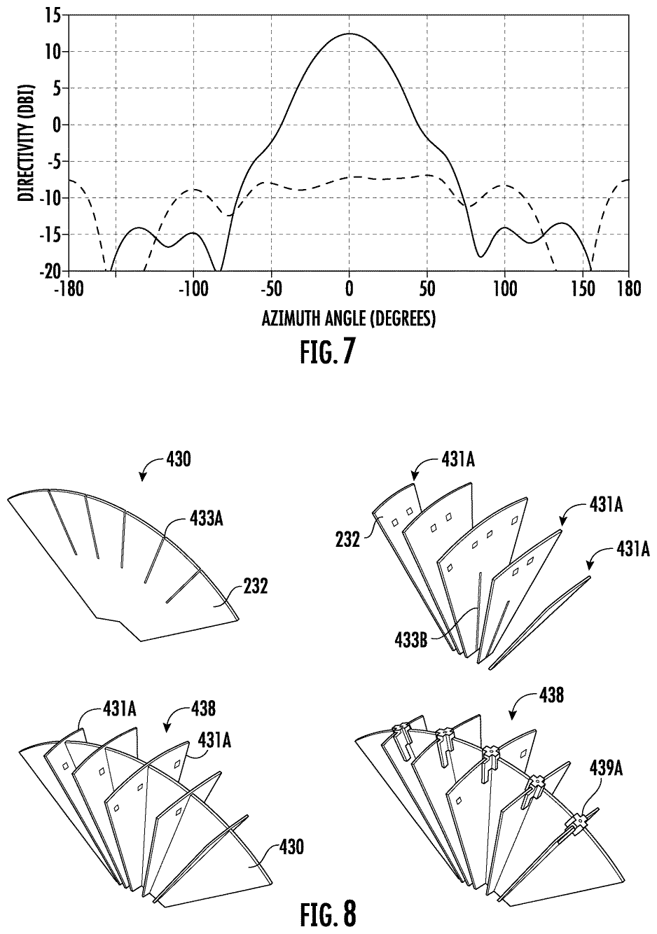

FIG. 7 is a graph of the simulated co-polar and cross-polar azimuth radiation patterns generated by the base station antenna of FIG. 6. The simulations are based on a 2 GHz RF excitation signal and the RF spherical lens 420 has a diameter of 200 mm and a has ten equally spaced-apart first laminae 430 and another ten equally spaced-apart second laminae 431. As shown in FIG. 7, the base station antenna 400 has a simulated directivity of approximately 12 dB, an azimuth HPBW of 40°, peak sidelobes that are less than −16 dB relative to maximum of the main lobe, and an axial cross-polar discrimination of 19 dB.

It will be understood that it may be difficult to construct the RF lens 420 included in the base station antenna 400 of FIG. 6 if both the first laminae 430 and the second laminae 431 form complete semicircles. FIG. 8 is a series of perspective views that schematically illustrate how the spherical RF lens 420 can be practically constructed. In particular, the upper left view in FIG. 8 is a perspective view of a portion of one of the first laminae 430, which would have a semicircular shape if fully depicted. The upper right view of FIG. 8 illustrates complete sub-segments 431A of five of the second laminae 431. Each second lamina 431e may include a plurality of the sub-segments 431A which together form a multi-piece second laminae 431 having a semicircular shape. As shown in the top views of FIG. 8, the dielectric substrates 232 of the first laminae 430 has a plurality of outwardly extending slots 433A that extend to the curved edge of the dielectric substrate 232, while the dielectric substrates 232 of each sub-segment 431A of the second laminae 431 has an inwardly extending slot 433B that extends to the straight edge of the dielectric substrate 232.

As shown in the lower left view of FIG. 8, the sub-segments 431A of the second laminae 431 may be mounted on the first laminae 430 by mating the slot 433B of each sub-segment 431A with a respective one of the slots 433A of the first laminae 430 to form a sub-assembly 438. Dielectric clips 439A hold the elements of sub-assembly 438 together.

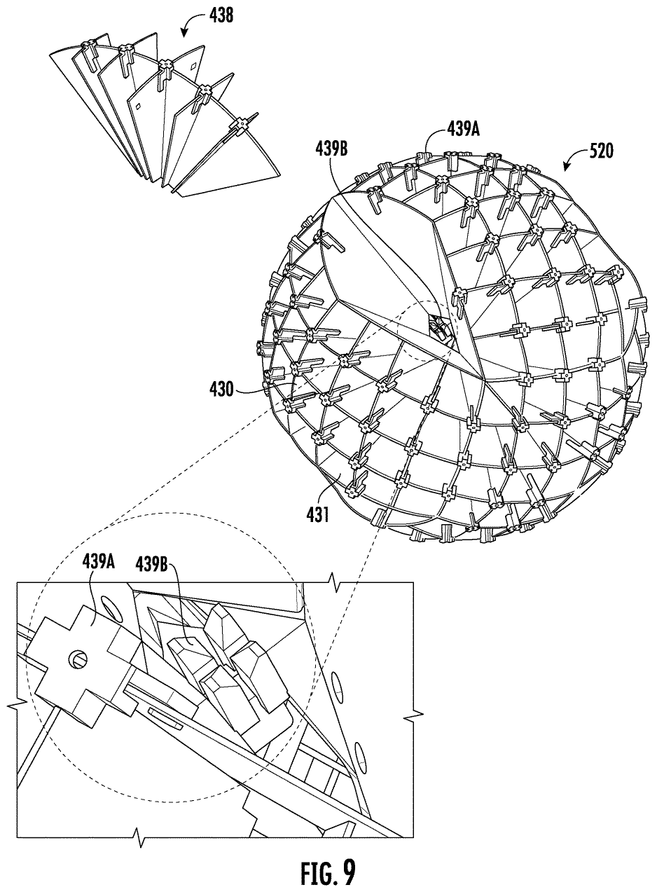

FIG. 9 is a schematic exploded perspective view of a spherical RF lens 520 that is a more practical version (i.e., a version with a larger number of first and second laminae 430,431) of the spherical RF lens 420 included in the base station antenna 400 of FIG. 6. The callout in FIG. 9 illustrates support elements that hold the sub-assemblies 438 in place. In particular, each of the plurality of sub-assemblies 438 is secured in place via a dielectric clip 439B, and all perimetral intersections between elements are secured by the dielectric clips 439A. Dielectric clips 439A are preferably provided with projections suitable for engagement in openings provided in the first and second laminae 430, 431.

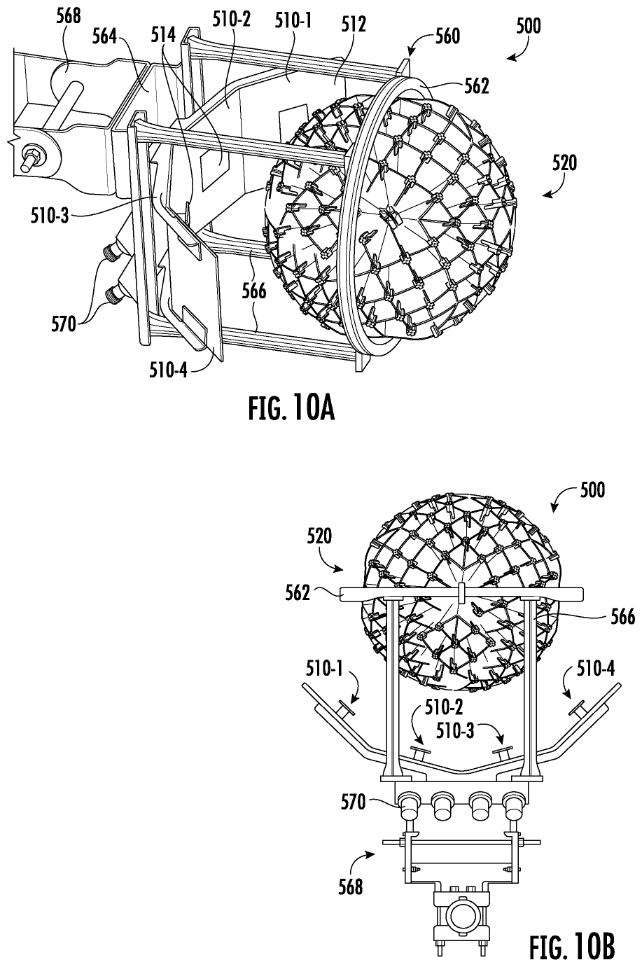

FIGS. 10A and 10B are a schematic perspective view and a schematic top view, respectively, of internal components of a base station antenna 500 according to still further embodiments of the present invention that includes the spherical RF lens 520 of FIG. 9. Base station antenna 500 comprises four radiating elements assemblies 510-1 through 510-4 that are supported by a structural member 560. Each radiating element assembly 510 comprises a reflector 512 and a radiating element 514 that extends forwardly from the reflector 512. The radiating elements 514 are oriented radially with respect to the center of the RF spherical lens 520. Spherical RF lens 520 is supported by support frame 560 that comprises an annular dielectric member 562 which is rigidly attached to structural member 564 by elongate dielectric members 566. RF connectors 570 are connected to the radiating elements 514 by way of RF transmission lines (not shown) that are provided at the rear of structural member 564. For the exemplary arrangement illustrated, a total of eight RF connectors 570 are provided that feed the four cross-dipole radiating elements 514. Structural member 564 is adjustably connected to a supporting structure by mounting member 568 which provides for adjustment of the azimuth and elevation orientation of the antenna beams generated by base station antenna 500.

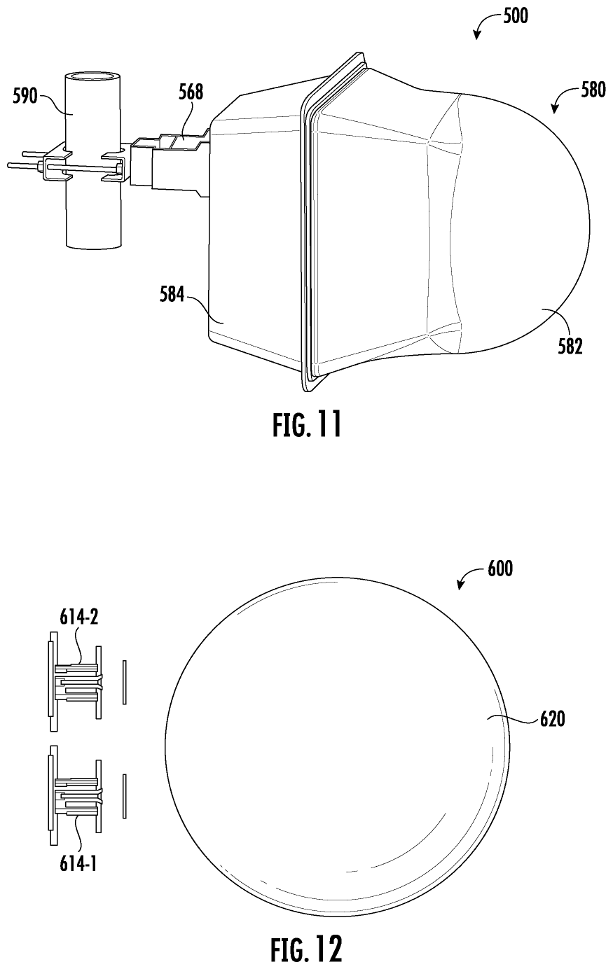

FIG. 11 is a schematic perspective view of the base station antenna of FIGS. 10A-10B with a weatherproof dielectric cover 580 installed. The weatherproof dielectric cover 580 comprises a front element 582 and rear element 584. The base station antenna 500 is secured by means of mounting member 568 that is fixed to a mounting pole 590.

FIG. 12 is schematic perspective view of internal components of a base station antenna 600 according to still further embodiments of the present invention that includes a spherical RF lens 620 that is illuminated by a co-phased pair of radiating elements 614-1, 614-2 that are spaced laterally apart by a one half of a wavelength that corresponds to a center frequency of the operating frequency band of the two radiating elements 614-1, 614-2. The two radiating elements 614-1, 614-2 are excited with nominally equal co-phased currents. The individual radiating elements 614-1, 614-2 are displaced in the vertical direction from the equatorial plane of the spherical RF lens 620. Thus, if the radiating elements 614-1, 614-2 were excited separately, the radiation patterns would have asymmetric off-axis radiation patterns. However, since the phase center of the array formed by the pair of radiating elements 614-1, 614-2 lies on the equatorial plane of the spherical RF lens 620, a satisfactory radiation pattern with low sidelobe levels is obtained. Spherical RF lens 620 may be any of the RF lenses disclosed herein.

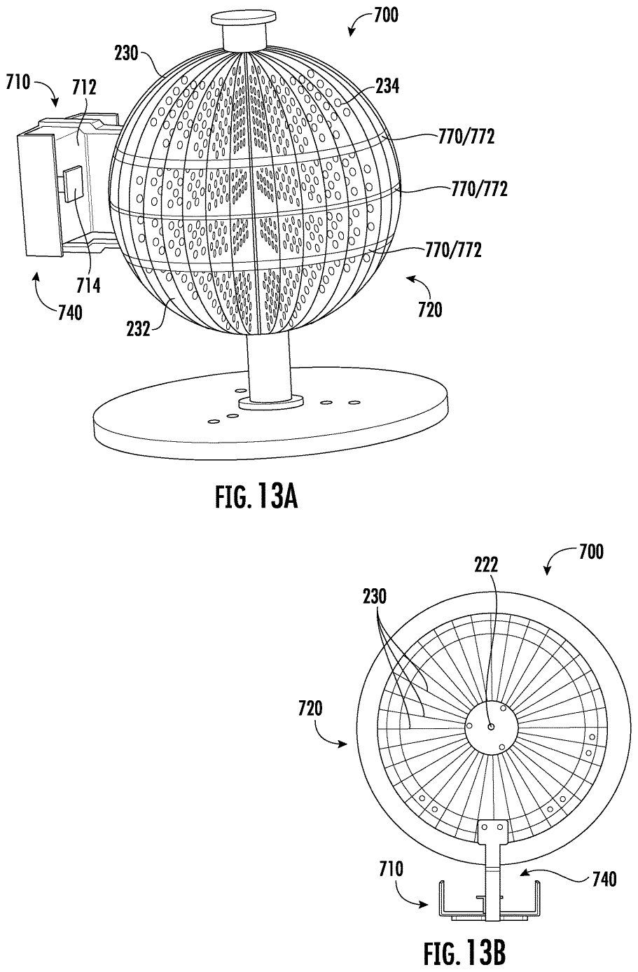

FIGS. 13A and 13B are a schematic perspective view and a schematic top view, respectively, of internal components of a base station antenna 700 according to additional embodiments of the present invention. Base station antenna includes a radiating element assembly 710, a spherical RF lens 720, and a support frame 740. The radiating element assembly 710 includes a reflector 712 and a cross-polarized radiating element 714. As the radiating element assembly 710 and support frame 740 are almost identical to the radiating assembly 210 and support frame 240 of base station antenna 200 of FIG. 3, further description of the radiating element assembly 710 and support frame 740 will be omitted here.

The spherical RF lens 720, like the spherical RF lens 220 shown in FIG. 3, includes a set of first laminae 230 that extend radially outward from a first axis 222. Each first laminae 230 comprises a semicircular planar dielectric substrate 232 and a plurality of conductive scattering elements 234 on at least one major surface of the planar dielectric substrate 232. As the first laminae 230 have been discussed in detail above, further description thereof will be omitted here. Spherical RF lens 720 further includes a set of second laminae 770. Each second laminae 770 extends in a respective plane that is perpendicular to planes defined by the major surfaces of the first laminae 230. Each second laminae 770 may intersect at least two of the first laminae 230. Each second laminae 770 may comprise a planar dielectric substrate 772 that has a semicircular shape. A plurality of slots may be formed in the dielectric substrate 772 that cooperate with corresponding slots in the dielectric substrates 232 of the first laminae 230 so that the first and second laminae 230, 770 may be interconnected in the fashion shown in FIG. 13A.

In some embodiments, at least one, and as many as all, of the second laminae 770 may be devoid of conductive scattering elements. In such embodiments, each second laminae 770 may simply comprise the dielectric substrate 772 such as a plastic plate. In embodiments where the second laminae 770 do not include any conductive scattering elements, it is axiomatic that the density of conductive scattering elements included in the second laminae 770 is less than the density of conductive scattering elements included in the first laminae 230 (since each first laminae 230 includes conductive scattering elements, while the second laminae 770 do not). In other embodiments, at least one of the second laminae 770 may comprise a dielectric substrate 772 that has at least one conductive scattering element (not shown) thereon. In such embodiments, the density of conductive scattering elements 234 on at least one of the first laminae 230 exceeds a density of conductive scattering elements (not shown) on at least one of the second laminae 770, and in some cases the density of conductive scattering elements on each of the first laminae 230 may exceed the density of conductive scattering elements (not shown) on at least one of the second laminae 770 and may exceed respective densities of conductive scattering elements (not shown) on all of the second laminae 770.

As shown in FIG. 13A, in some embodiments, the number of first laminae 230 exceeds the number of second laminae 770. In other embodiments, the number of first laminae 230 may be at least twice, at least three times, at least four times or at least five times the number of second laminae 770. Moreover, a thickness of at least one of the second laminae 770 may exceed a thickness of at least one of the first laminae 230, and may exceed the thicknesses of all of the first laminae 230. The first and second laminae 230, 770 may define an ellipsoid. For example, the curved edges of the first and second laminae 230, 770 may define a sphere.

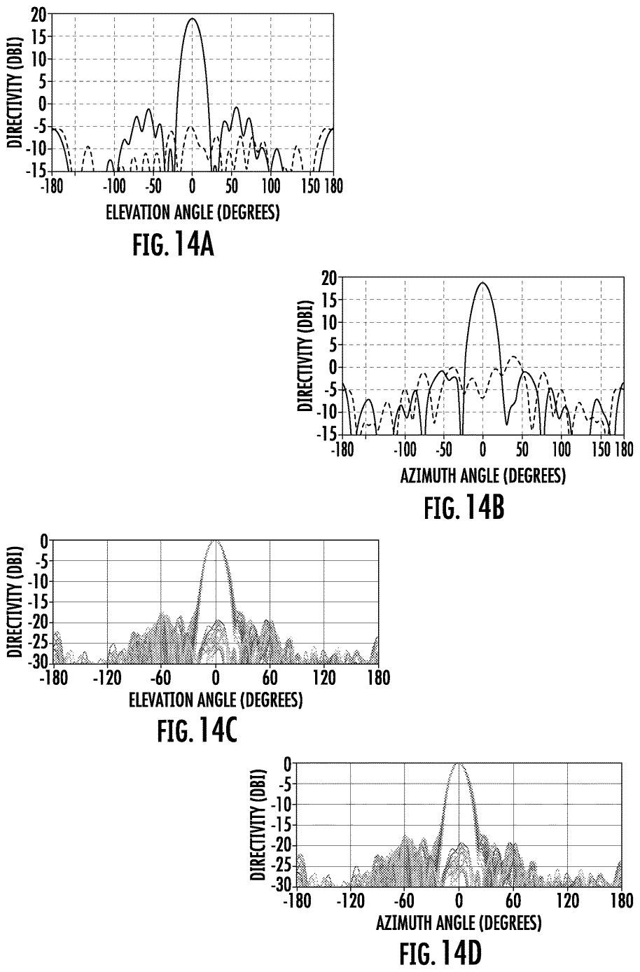

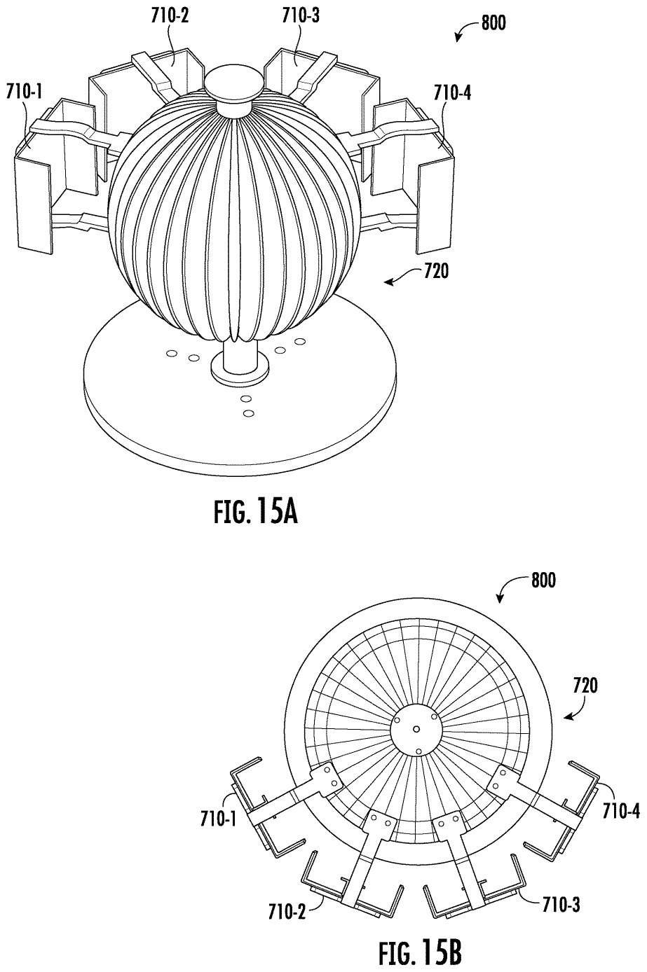

FIG. 14A is a graph of the simulated co-polar and cross-polar elevation radiation patterns generated by the base station antenna of FIGS. 13A-13B. FIG. 14B is a graph of the simulated co-polar and cross-polar azimuth radiation patterns generated by the base station antenna of FIGS. 13A-13B. FIG. 14C is a graph of the measured co-polar and cross-polar elevation radiation patterns generated by the base station antenna of FIGS. 13A-13B at frequencies in the range of 3.3-4.0 GHz. FIG. 14D is a graph of the measured co-polar and cross-polar azimuth radiation patterns generated by the base station antenna of FIGS. 13A-13B at frequencies in the range of 3.3-4.0 GHz.

As shown in FIGS. 14A-14D, base station antenna 700 has excellent co-polar patterns in both the azimuth and elevation planes, and exhibits high directivity while having very low sidelobe levels and excellent cross-polarization discrimination. The simulated and measured performance also track well.

FIGS. 15A and 15B are a schematic perspective view and a schematic top view, respectively, of internal components of a base station antenna 800 according to additional embodiments of the present invention. As can be seen by comparing FIGS. 13A-13B to FIGS. 15A-15B, base station antenna 800 is identical to base station antenna 700 of FIGS. 13A-13B except that base station antenna 800 includes four radiating element assemblies 710 instead of the single radiating element assembly 710 included in base station antenna 700. Base station antenna 800 can generate four antenna beams (per polarization) to provide service to four sub-sectors of a coverage area.

When multiple arrays of radiating elements (note that each array can include a single radiating element) are mounted behind a metamaterial RF lens that has conductive scattering elements that extend in perpendicular planes, undesired coupling may occur between the radiating elements which can act to degrade the antenna beams and increase interference levels. Typically, the coupling levels may be around 20 dB or worse, which can degrade performance. Measured isolation performance for spherical RF lens 720 exceeds 28 dB. The spherical RF lens 720 of base station antenna only implements conductive scattering elements in the vertical planes, and simply uses dielectric substrates as the focusing media in the horizontal planes. It has been found that this arrangement may greatly reduce coupling between the radiating elements. The number, thickness and/or dielectric constants of the second laminae 770 may be adjusted to achieve sufficient focusing in the horizontal plane. It has been found that a small number of second laminae 770 may be used, particularly if they are thickened and/or formed of high dielectric constant material. This may simplify construction of the spherical RF lens 720 and reduce the cost thereof.

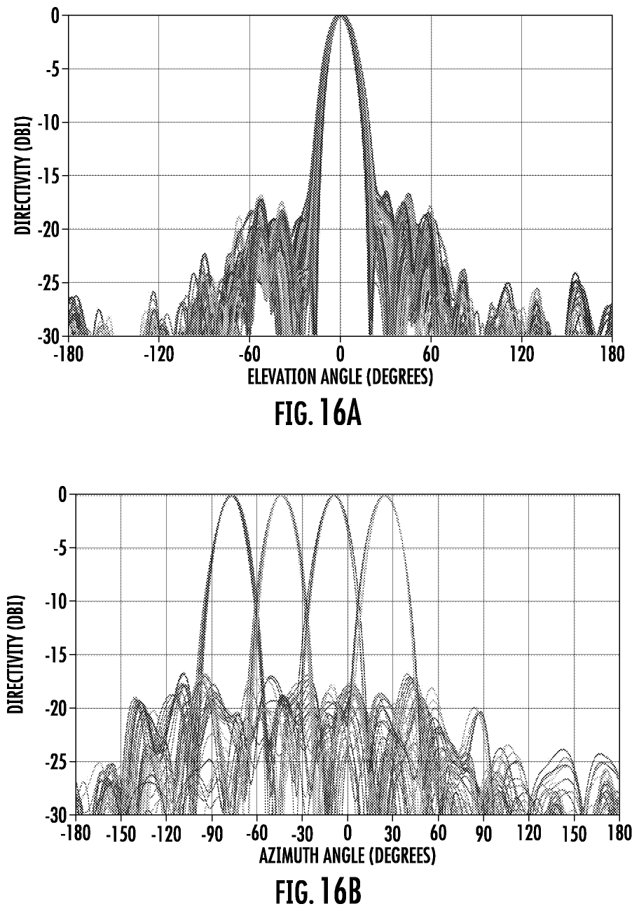

FIG. 16A is a graph of the measured co-polar elevation radiation patterns generated by the base station antenna of FIGS. 15A-15B at frequencies in the range of 3.3-4.0 GHz. FIG. 16B is a graph of the measured co-polar azimuth radiation patterns generated by the base station antenna of FIGS. 15A-15B at frequencies in the range of 3.3-4.0 GHz. As shown in FIGS. 16A-16B, the azimuth and elevation patterns of the antenna beams generated by base station antenna 800 are well controlled, with no distortion between antenna beams in the azimuth plane.

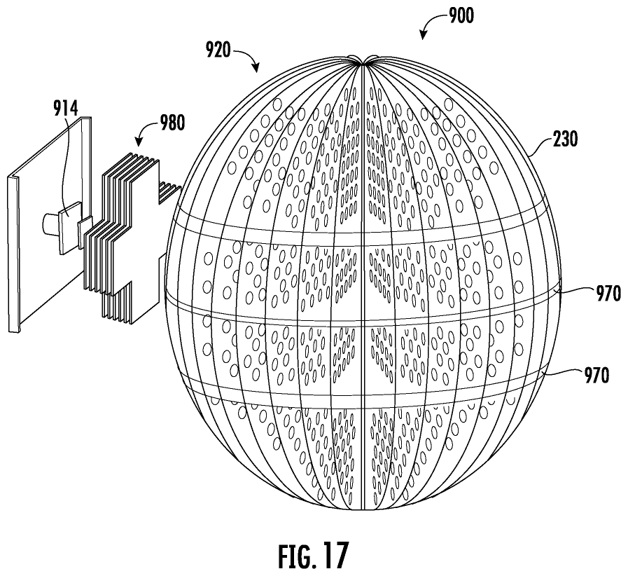

FIG. 17 is a schematic perspective view of internal components of a base station antenna 900 according to another embodiment of the present invention. Base station antenna 900 is similar base station antenna 800, so the discussion below will focus on the differences between the two antennas.

Base station antenna 900 includes an ellipsoid RF lens 920. As shown, the ellipsoid RF lens 920 is not a spherical RF lens, but instead is a non-spherical ellipsoid RF lens. Thus, it will be appreciated that the RF lens included in the bae station antennas according to embodiments of the present invention can have ellipsoid RF lenses that have spherical or non-spherical shapes.

Ellipsoid RF lens 920 includes a total of two second laminae 970 instead of three second laminae as was the case with the spherical RF lens 720 shown in FIGS. 13A and 15A. The second laminae 970 may be identical to the second laminae 770 of spherical RF lens 720 so further description thereof will be omitted here. RF lens 920 shows that the number of second laminae included in the RF lenses of the base station antennas according to embodiments of the present invention may be varied, and that the positions of the second laminae may also be varied. For example, in RF lens 920, a second laminae 970 is not provided at the equatorial plane of the ellipsoid RF lens 920.

As is further shown in FIG. 17, a secondary lens 980 is provided that is positioned in between the radiating element 914 of base station antenna 900 and the ellipsoid RF lens 920. The secondary lens 980 in the depicted embodiment comprises a metamaterial based RF lens that comprises a plurality of dielectric substrates that have conductive scattering elements formed thereon. The function of the secondary lens 980 can be explained as follows. Using base station antenna 800 of FIGS. 15A-15B as an example, the focal point of the RF lens 720 is typically quite close to the RF lens 720. Therefore, the radiating elements 714 in the radiating element assemblies 710-1 to 710-4 should be positioned close to the RF lens 720. However, as the radiating elements 714 are positioned closer to the RF lens 720, the coupling between the radiating elements 714 may increase, resulting in degraded beam-to-beam isolation. As the radiating elements 714 are moved further away from the RF lens 720, the beamwidths in both azimuth and the elevation planes is not optimized for illuminating the RF lens 720 at the new (increased) distance. In particular, the beamwidths may become too wide so that the antenna beams generated by the radiating elements 714 over illuminate the RF lens 720. This results in poorer sidelobes. In order to correct this, the beamwidth needs to be reduced so that it illuminates the RF lens 720 properly. The purpose of the secondary lens 980 is to narrow this beamwidth to a value (e.g., reducing the beamwidth from 65° to 50°) so that the individual radiating element antenna beams properly illuminate the RF lens 720 for the chosen distance. As the radiating elements 714 are moved away from the RF lens 720, the radiating elements 714 are further apart from each other resulting in less coupling between them.

The secondary lens 980 may be implemented, for example, using any of the planar metamaterial lenses disclosed in the above-referenced '936 application.

It is to be understood that the conductive scattering elements discussed above are conductive structures having dimensions that are small compared with the wavelength at the operating frequency of the antenna. Conductive scattering elements may be in the form of concentric circles or concentric squares as described in U.S. patent application Ser. No. 18/298,795, but the present invention is not limited to the use of those shapes.

It will be appreciated that many modifications may be made to the example base station antennas described above without departing from the scope of the present invention. For example, the operating frequency, bandwidth, gain, beamwidths, sidelobe levels, cross-polarization discrimination may all vary from the examples shown herein, as may external diameter of the RF lenses, the number and spacing of the laminae, the number and spacing of conductive scattering elements, the configuration of the scattering elements and their mutual disposition, and the positioning and beamwidths of the radiating elements.

As a few examples of changes that may be made, in some embodiments, the conductive scattering elements may have the same configuration on each laminae, while in other embodiments the configuration may differ between shells. In some embodiments the spacing between conductive scattering elements may be the same on each laminae, while in other embodiments the said spacing may differ between laminae. In some embodiments, the conductive scattering elements may be formed on FR4 substrates by implementing the laminae using printed circuit boards. A thickness of the dielectric substrate of 0.76 mm (30 mil) is found to be convenient.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Herein, a first element overlaps a second element in a given direction (e.g., the forward direction) if an axis that extends in the direction passes through both elements.

Herein, the term “substantially” refers to variation of less than 10%, unless otherwise noted.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A base station antenna, comprising:
an RF lens that comprises:
a set of first laminae, each first laminae extending radially outward from an axis;
a set of second laminae, each second laminae intersecting at least two of the first laminae; and
a radiating element that is configured to radiate toward the RF lens.

2. The base station antenna of claim 1, wherein each second laminae extends in a respective plane that is perpendicular to planes defined by the major surfaces of each first laminae.

3. The base station antenna of claim 1, wherein a first number of first laminae in the set of first laminae exceeds a second number of second laminae in the set of second laminae.

4-5. (canceled)

6. The base station antenna of claim 1, wherein each first laminae comprises a planar dielectric substrate and a plurality of conductive scattering elements on at least one major surface of the planar dielectric substrate, and each second laminae comprises a dielectric substrate which optionally may have one or more conductive scattering elements on at least one major surface thereof, and wherein a density of conductive scattering elements on at least one of the first laminae exceeds a density of conductive scattering elements on at least one of the second laminae.

7-8. (canceled)

9. The base station antenna of claim 1, wherein each first laminae comprises a planar dielectric substrate and a plurality of conductive scattering elements on at least one major surface of the planar dielectric substrate, and at least one of the second laminae is devoid of conductive scattering elements.

10. (canceled)

11. The base station antenna of claim 1, wherein each first laminae includes a straight edge and a curved edge that connects to opposed ends of the straight edge.

12-13. (canceled)

14. The base station antenna of claim 11, wherein the first laminae and the second laminae are semicircular laminae.

15. The base station antenna of claim 11, the RF lens further comprising a cylindrical support element, wherein the straight edges of the first laminae are received within slots in the cylindrical support element.

16. (canceled)

17. The base station antenna of claim 1, wherein the radiating element is a first radiating element, the base station antenna further comprising a second radiating element that is configured to radiate toward the RF lens, where a boresight pointing direction of the second radiating element is parallel to the plane defined by the major surface of the first of the second laminae.

18. A base station antenna, comprising:
an RF lens that comprises:
a set of first laminae, each first laminae extending in a respective one of a plurality of vertical planes;
a set of second laminae, each second laminae extending in a respective one of a plurality of horizontal planes; and
a radiating element that is configured to radiate toward the RF lens,
wherein each first laminae comprises a planar dielectric substrate and a plurality of conductive scattering elements on at least one major surface of the planar dielectric substrate.

19. The base station antenna of claim 18, wherein a first number of first laminae in the set of first laminae exceeds a second number of second laminae in the set of second laminae.

20. (canceled)

21. The base station antenna of claim 18, wherein a thickness of at least one of the second laminae exceeds thicknesses of every one of the first laminae.

22. The base station antenna of claim 18, wherein a density of conductive scattering elements on at least one of the first laminae exceeds a density of conductive scattering elements on at least one of the second laminae.

23-26. (canceled)

27. The base station antenna of claim 18, wherein a boresight pointing direction of the radiating element is parallel to a plane defined by a major surface of a first of the second laminae.

28-37. (canceled)

38. A base station antenna, comprising:
an RF lens that comprises:
a set of first laminae, each first laminae extending in a respective one of a plurality of vertical planes;
a set of second laminae, each second laminae extending in a respective one of a plurality of horizontal planes; and
a radiating element that is configured to radiate toward the RF lens,
wherein each first laminae comprises a planar dielectric substrate and a plurality of conductive scattering elements on at least one major surface of the planar dielectric substrate and each second laminae comprises a dielectric substrate, and
wherein a density of conductive scattering elements on at least one of the first laminae exceeds a density of conductive scattering elements on at least one of the second laminae.

39. The base station antenna of claim 38, wherein a first number of first laminae in the set of first laminae exceeds a second number of second laminae in the set of second laminae.

40-41. (canceled)

42. The base station antenna of claim 38, wherein the density of conductive scattering elements on the at least one of the first laminae exceeds a density of conductive scattering elements on all of the second laminae.

43. The base station antenna of claim 42, wherein at least one of the second laminae is devoid of conductive scattering elements.

44. The base station antenna of claim 38, wherein each first laminae includes a straight edge and a curved edge that connects to opposed ends of the straight edge.

45. (canceled)

46. The base station antenna of claim 44, the RF lens further comprising a cylindrical support element, wherein the straight edges of the first laminae are received within slots in the cylindrical support element.

47-73. (canceled)
